(19) United States
(12) Patent Application Publication
(10) Pub. No.: US 2011/0212218 A1
(43) Pub. Date: Sep. 1, 2011

(54) Method for modulating animal digestive tract microbiota and feed composition comprising bark extract

(75) Inventors: Kaisa Herranen, Tampere (FI); Suvi Pietarinen, Lappeenranta (FI); Kari Luukko, Espoo (FI); Ulf Hotanen, Lappeenranta (FI); Marko Lauraeus, Vihti (FI); Juha Apajalahti, Helsinki (FI); Juhani Vuorenmaa, Kangasala (FI)

(73) Assignee: UPM-KYMMENE CORPORATION, Helsinki (FI)

(21) Appl. No.: 12/939,685

(22) Filed: Nov. 4, 2010

(30) Foreign Application Priority Data
Nov. 4, 2009 (FI) 20096137

(51) Int. Cl. A23K 1/16; A23K 1/18

(52) U.S. Cl. 426/2; 426/655; 426/648; 426/71

(57) ABSTRACT

The present invention relates to a method for modulating animal digestive tract microbiota wherein the modulating comprises adding an extract of birch bark to animal feed. The invention further relates to a feed composition comprising a birch bark extract for enhancement of animal performance and gastrointestinal health.

### FIELD OF THE INVENTION

The present invention relates to a method for modulating animal digestive tract microbiota wherein the modulating comprises adding a birch bark extract to animal feed. The invention further relates to a feed composition comprising birch bark extract which is effective in modulating animal digestive tract microbiota. The preferred birch bark extract comprises 10 to 50 w-%, preferably 20 to 35 w-%, more preferably 20 to 30 w-% of Betulinol and 10 to 40 w-%, preferably 10 to 20 w-% of long chain fatty acids. Typically the preferred birch bark extract further comprises 3 to 8 w-% of Lupeol.

### BACKGROUND OF THE INVENTION

Intestinal disorders and microbial unbalances cause a lot of production losses, for example when monogastric animals like broilers and piglets, are raised. Especially new-born animals are prone to intestinal disorders that weaken their growth and productivity, and some cases causes increased mortality.

Microbial infections of animals have been prevented by the use of antibiotics and coccidiostats in feeds. However, feed antibiotics are banned in EU and in several other countries and regulations on their use are expected to become stricter globally in the future. Coccidiostats are regularly added to poultry feeds in order to control the Eimeria and the microbes that cause intestinal infections. Regulations on their use are also anticipated to be restricted.

Recent research has shown that the composition of the commensal microbiota in the gastrointestinal (GI) tract correlates with animal performance. Different bacterial populations have proven to have different effects on the growth and feed utilization of monogastric animals. For example Vaahtovuo J. et al 2007 (Livestock Science 109 (2007) 174-178) have described Microbial Balance Index associating with animal growth. McCracken et al. 2006 (Chicken caecal microflora correlates with ME:GE using wheat-based diets. Proceedings of the XII WPSA European Poultry Conference, 10-14 September, Verona, Italy) demonstrated a strong correlation between caecal micro flora patterns of broilers and diet metabolisability. Diet composition and feed ingredients have effects on the composition of the commensal microbiota and animal performance. For example, antibiotic growth promoters are not only preventing the growth of pathogenic microbes, but also modulate the composition of the commensal microbiota. Further, there are some other feed ingredients which are also modulating the composition of the commensal microbiota. Such ingredients are natural products like herbal extracts, organic acids, prebiotics, probiotics and enzymes.

Further consumer awareness is increasing and people are more and more willing to buy products with low environmental load. Methane production of ruminants is a remarkable part of global green-house gas emissions and it will be important in the future to be able to reduce the methane production of ruminants. It is known that ionophoric coccidiostats are able to reduce the methane production of ruminants but their use is currently prohibited for example in the European Union. There is a growing need to find natural ingredients capable to reduce the methane production in ruminants like dairy cows, beef cattle, goats and sheep.

Moreover, the efficacy of prior art ingredients and methods described above for modulating the composition of the microbiota and/or its metabolism and/or preventing undesired microbial growth and metabolism in the digestive tract of animals has not been consistent and satisfactory. Consequently, there is a growing need to find new ingredients to control digestive tract microbiology. There is a need for non-toxic, well tolerated and environmentally friendly natural substances capable to efficiently modulate the commensal microbiota in the GI tract so that the health and productivity of the animals is enhanced. The present invention aims at satisfying that need.

It should be noted that all documents cited in this text (“herein cited documents”) as well as each document or reference cited in each of the herein-cited documents, and all manufacturer's literature, specifications, instructions, product data sheets, material data sheets, and the like, as to the products and processes mentioned in this text, are hereby expressly incorporated herein by reference.

### SUMMARY OF THE INVENTION

The present invention relates to a method for modulating animal digestive tract microbiota wherein the modulating comprises adding a birch bark extract to animal feed wherein the birch bark extract comprises 10 to 50 w-%, preferably 20 to 35 w-%, more preferably 20 to 30 w-% of Betulinol and 10 to 40 w-%, preferably 10 to 20 w-% of long chain fatty acids. Typically the birch bark extract further comprises 3 to 8 w-% of Lupeol.

The present invention further relates to a feed composition comprising a birch bark extract for modulating the composition of digestive tract microbiota and/or its metabolism. The birch bark extract is given separately or in combination with other feed components to different animals, such as monogastric animals, ruminants and/or aquaculture.

Benefits of the invention are; improved animal health and productivity; higher product quality, inter alia with regard to uniformity, nutritional value, food safety; lower cost per production unit; increased product safety and/or decreased environmental load.

Further benefits of the microbial modulation method of the invention relate to different detailed mechanisms in the animal digestive tract. Modulation of microbiota and/or its metabolism increases nutrient absorption in upper and lower digestive tract, weaken or prevent adverse processes, for example pathological processes, direct or indirect, in animal digestive tract, weaken or prevent pathogen growth in digestive tract and/or prevent release of harmful substances in the digestive tract regardless where these have initially been formed.

Preferably the birch bark extract is effective in modulating the composition of the commensal microbiota of the animals to a direction that is beneficial for the animal performance. One object of the present invention is to use a birch bark extract to affect and/or decrease the population of the intestinal microbes, inhibiting the metabolism of these microbes, changing the microbial population and/or shifting the microbial metabolism.

Typically improved performance of healthy animals by modulated microbial population in the upper digestive tract is due to more energy released from feed being used for the animals' own growth and less being consumed by bacteria leading to animals growing faster with the same feed amount. Another object of the invention is thus to decrease the potential of microbes which compete with the absorption mechanisms of the host animal in the upper digestive tract.

A further object of the invention is to prevent impaired performance and gastrointestinal disorders of animals.

A still further object of the invention is adding birch bark extract to animal feed or feed composition for binding mycotoxins, moldtoxins or bacterial toxins.

Another object of the invention is adding birch bark extract for binding or preventing growth of intestinal parasites such as Eimeria or Cryptosporidium parvum.

### DETAILED DESCRIPTION OF THE FIGURES

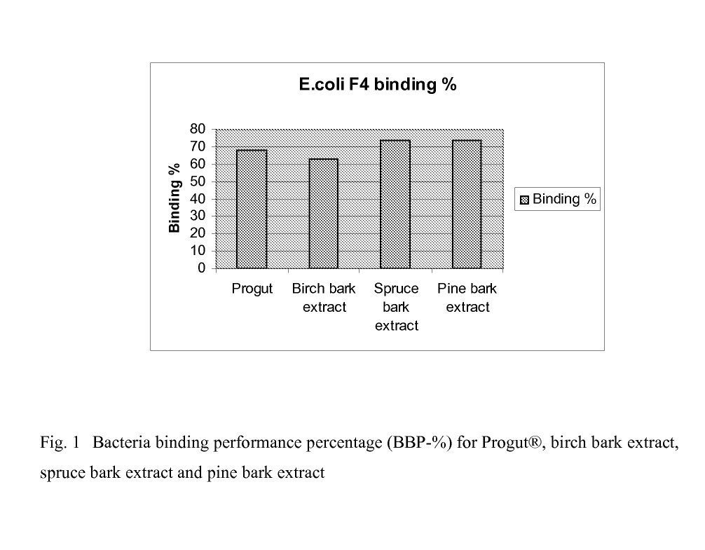

FIG. 1 Bacteria binding performance percentage (BBP-%) for Progut®, birch bark extract, spruce bark extract and pine bark extract

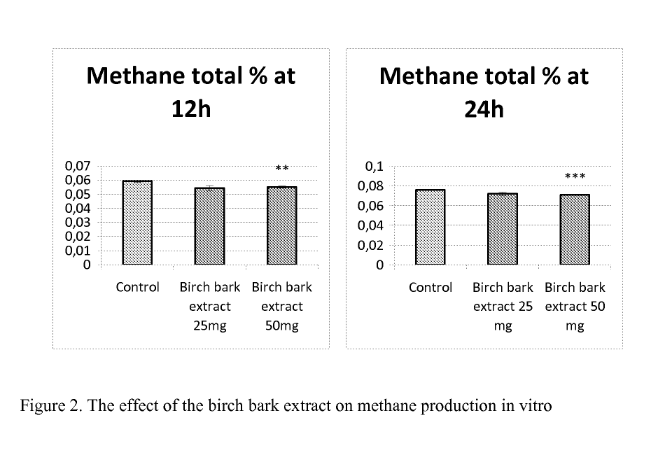

FIG. 2. The effect of the birch bark extract on methane production in vitro

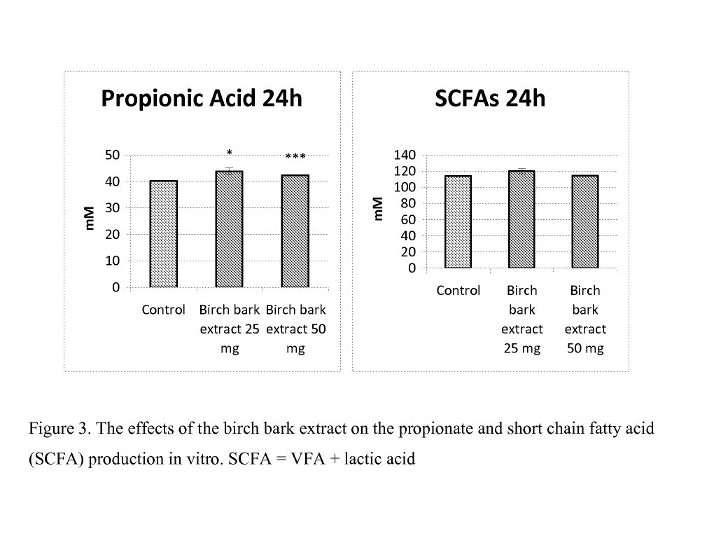

FIG. 3. The effects of the birch bark extract on the propionate and short chain fatty acid (SCFA) production in vitro. SCFA=VFA+lactic acid

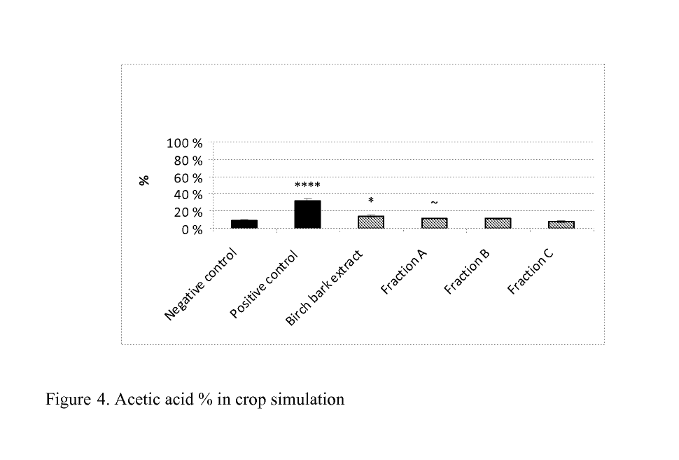

FIG. 4. Acetic acid % in crop simulation

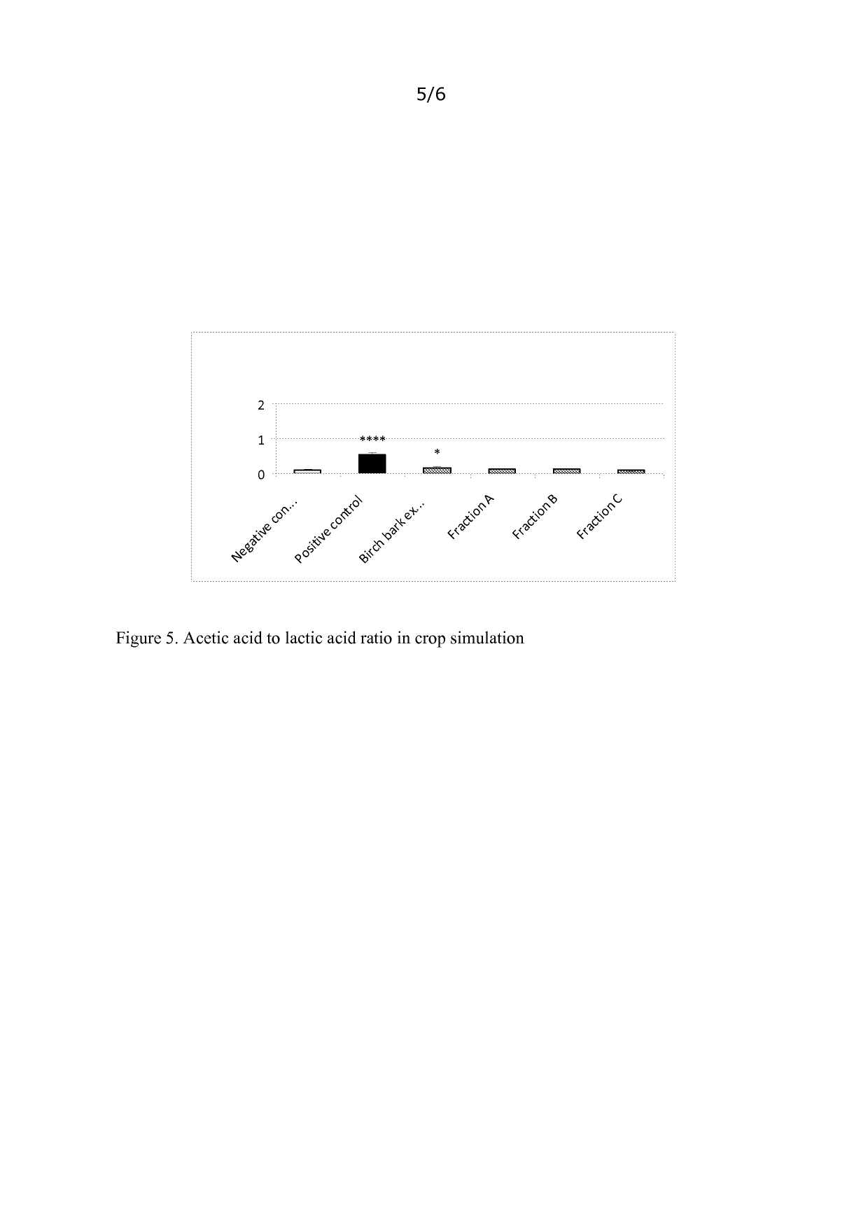

FIG. 5. Acetic acid to lactic acid ratio in crop simulation

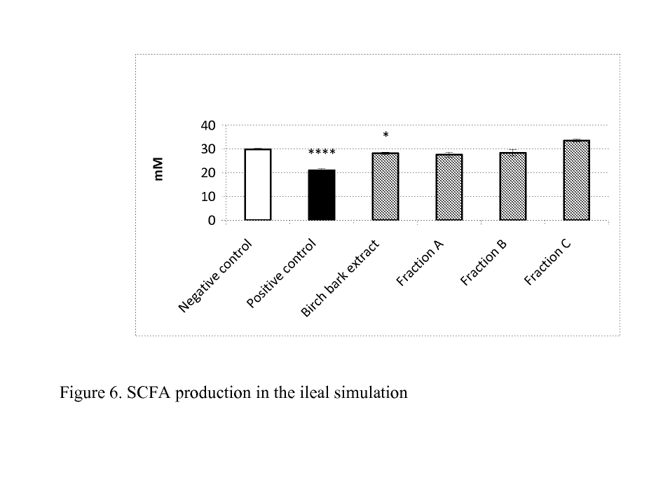

FIG. 6. SCFA production in the ileal simulation

### DETAILED DESCRIPTION OF THE INVENTION

The present invention is based on the realization that birch bark extracts can be used as modulators of the digestive tract microbiota and/or metabolism. The microbial modulator, i.e. the birch bark extract of the invention is effective in modulating the composition of the microbiota to a direction that is beneficial for the animal health and performance. It is enhancing nutrient absorption in upper and lower digestive tract, preventing adverse microbial processes, preventing undesired microbial growth and/or metabolism, decreasing adverse environmental effects and/or decreasing the formation and/or absorption of harmful substances in the animal digestive tract. Thus benefits to animal performance, health, production economy and/or environmental load are achieved.

In the present specification and claims, the following terms have the meanings defined below.

The term “feed” or “animal feed” as used in the description and claims refers to the total feed composition of an animal diet or to a part of it. Thus, unless specifically stated, the term “feed” or “animal feed” should be taken to mean to include supplemental feed premixes etc. The feed may comprise different active ingredients.

The term “animal” as used in the description and claims refers to all kind of different animals, such as monogastric animals, ruminants and aquaculture including fish and shellfish. The animals may be production animals as well as pets. Examples of different animals, including offspring, comprise cows, beef cattle, pigs, poultry, sheep, goats, horses, cats, dogs, shrimps and scampi.

The term “digestive tract” refers to the whole digestive tract that differs from species to species. Comprehensively the digestive tract in all animals can be functionally divided to three separated compartments; the storage compartment, the main digestive and absorption process compartment and the main microbial fermentation compartment. The term digestive tract refers to all three compartments regardless their differences among various species.

The term “modulating” refers to affecting the digestive tract microbiota. Modulating refers to inhibiting or stimulating the growth of the whole digestive tract microbiota or any portion of the microbiota. Furthermore, modulating refers to inhibiting or stimulating the metabolism of the whole microbiota, the metabolism that is specific to any portion of the microbiota or any single metabolic reaction and/or combination of metabolic reactions. Modulating also refers to changes in interaction of microbiota members with each other and with the host.

The term “microbiota” refers to the microorganisms that typically inhabit the digestive tract. Microbiota is also called microbial flora and varies for different species.

The term “microorganism” or “microbe” refers to members of archaea and bacteria domains and microscopic members of Eukaryote domain.

The term “microbial modulator” as used in the description refers to a birch bark extract of the invention.

The term “bark extract” refers to an extract of bark comprising one or more active components obtained when bark has been extracted with a solvent. The bark is preferable grinded or powdered before it is subjected to extraction. The extract is initially in a liquid form in the extracting solvent medium and the solid extract is typically obtained by evaporation of the solvent. The solvent typically used for obtaining the extract of the present invention comprises; alcohols, such as ethanol, isopropanol or isopropyl; acetone; cyclohexane; hexane: heptane; water; supercritical carbon dioxide or mixtures thereof. The pH during extraction is adjusted by NaOH. The bark material can be purified by extracting the material with other solvents or the extract can be further modified by sequential extraction with solvents of different polarity. E.g. liquid-liquid extraction can be used to remove unwanted components like lipophilic wood extractives. In some cases exchanging of solvent to e.g. glycerol or vegetable oil can be done. The extract is preferably a mixture of active compounds of bark.

The microbial modulator of the invention i.e. the extract of bark and the active compounds thereof, is a natural product which has a sustainable and environmentally friendly character. It has a generally low toxicity and is well tolerated at levels which are effective in affecting animal digestive tract microbiota. The extracts can be used as such or they can be fractionated into specific components.

When a fraction of the bark extract is used instead of the whole extract there is a possibility to affect the microbial modulator or the feed for example regarding the taste or flavor, the product safety, the tastiness, the consistence or the usability. One object of the invention is the use of the microbial modulator as an aromatic compound of an animal feed.

Birch outer bark contains betulinol, suberin and phenolic groups. Birch bark comprises 30 to 60% of Suberin. The Suberin consists of long chain fatty acids. Part of the fatty acids contains epoxy groups and other functionalities, such as hydroxyl groups. The fatty acids can also be bond to phenolic groups. The following species; Fagus sylvatica, Quercus robur, Quercus suber, Pseudotsuga menziesii, Acer pseudoplatanusI and/or Acer griseum has been described to be remarkable Suberin sources (Gandini et al. “Suberin; A promising renewable resource for novel macromolecular materials”, Progress in Polymer Science, 31: 878-892) along with different Betula species.

Different methods for isolation of birch bark extracts have been described in WO 2007/045729 A1 or U.S. Pat. No. 4,732,708 where an oxidation step is carried out at 200-400° C. with potassium permanganate or chromic acid, in WO 2007/121482 A1 where pure betulinol and suberin fatty acids are isolated involving purification of the extract with water insoluble solvents and crystallization of betulinol from this solvent fraction. In WO 2005/0158414 A1 a sequential isolation method for pure suberin acids is described and WO 2008/027426 A1 relates to pelletizing birch bark with alkali prior to extraction for pure betulinol production.

However, prior art has not suggested a feed composition for modulating animal digestive tract microbiota wherein the modulating comprises adding a birch bark extract to an animal feed according to the invention. In the present invention the microbial modulator comprises an extract of bark. Typically the microbial modulator is inserted to an animal feed composition, which can be distributed directly from the package, for example from a bag or from a dosing feeder or machine. In case the microbial modulator is part of a feed supplement, which is added in small amounts to the total feeding or feed composition; is part of a feed premix, where the microbial modulator together with optional other compounds is mixed with a filler before mixing the premix into the total feeding or feed composition or is given to the animal as a medicine-like natural healthcare product, then the amount of microbial modulator corresponds to the concentrations in the feed as a whole.

There are various mechanisms by which the microbes cause reduced animal performance, health and value to the food chain. For example an agent interfering with the infection process will improve animal performance and decrease disease risk, especially for microbes, such as Escherichia coli, which attach directly to gut epithelial lining and cause intestinal disease. Further an agent that can either decrease primary infection or alleviate the symptoms of consequent secondary infections, for example by toxin neutralization, will increase animal performance and health. This is especially true for intracellular parasites, such as Eimeria or Cryptosporidiosis, that infect epithelial lining and decrease its functions thereby directly decreasing animal performance and for parasites which stimulate the growth and toxin production of another microbe, such as Clostridium perfringens that cause more severe performance deterioration or even death of the host animal. Moreover reduced feed efficiency is caused by microbes competing with the host regarding the nutrient absorption, which is due to extensive microbial growth in upper digestive tract. A further mechanism is a densely growing, diverse and right type of metabolic pathway containing microbial population which increases animal growth and performance, since non-utilized feed components in the lower digestive tract is converted to a chemical form utilizable by the host absorption system. A still further mechanism is means, direct or indirect, to remove human pathogens such as Salmonella and Cambylobacter from the digestive tract which increases the value of the animal products. The pathogens, are not necessary harmful to the animal host, but are able to contaminate animal products and cause human diseases.

In preferable embodiments of the invention the bark extract of the modulating method and the feed composition is effective in prevention of gastrointestinal disorders of animals, enhancing animal performance and gastrointestinal health, enhancing feed conversion rate and changing the microbial population and/or its metabolism in the digestive tract of animals to a direction that is beneficial for the performance and/or the gastrointestinal health of animals, for example by enhancing nutrient absorption in upper and lower digestive tract, by reducing the total number of microbes in the upper digestive tract of monogastric animals; by preventing adverse microbial processes; by preventing undesired microbial growth and/or metabolism, decreasing adverse environmental effects and/or decreasing the formation and/or absorption of harmful substances in the animal digestive tract. Adverse processes are different unwanted processes including for example pathological processes.

In one preferred embodiment of the invention the modulating of the animal digestive tract microbiota comprises changing the microbial population, for example by preventing, inhibiting and/or reducing undesired microbial growth and/or metabolism and/or shifting the microbial metabolism for example by increasing preferred microbial growth.

Typically the microbial modulator, i.e. the birch bark extract of the invention is effective in increasing the number of bacteria in lower digestive tract, especially bacteria groups like Clostridium cluster IV and XIVa and Bifidobacteria that have beneficial effects on animal performance, for example on the growth of monogastric animals. In addition shifting the microbial metabolism from homofermentative lactic acid pathway to heterofermentative direction increases the acetic acid to lactic acid ratio and enhances animal performance. Typically the microbial modulator of the invention is effective in shifting the microbial metabolism in the lower digestive tract. Control of homofermentative lactic acid fermentation in the animal gastrointestinal tract is one potential beneficial effect by growth promoting feed additives, like feed antibiotics.

In another embodiment of the invention the birch bark extract is effective in reducing the total number of microbes and/or their metabolism in the upper digestive tract of monogastric animals. This leaves more of the energy released from the feed for the animals' own use when less is consumed by bacteria. As a result the animal grows faster with the same amount of feed.

According to further embodiments of the invention the growth is inhibited or the pathogenic activity of harmful microbes decreased. Typically microbes like Escherichia coli and Salmonella are bound to the microbial modulator, i.e. the birch bark extract and/or the attachment of the microbes to the digestive tract is inhibited and/or the receptors to which they attach are blocked. Another typical example is that the growth of microbes like Clostridium perfinges and Streptococcus spp is inhibited or delayed. Also toxins produced by pathogenic bacteria like Clostridium perfringes and E. coli can be detrimental for animal health and productivity. According to the invention their harmful effects can be prevented by either preventing the growth of the pathogenic organisms or by binding and making the toxins ineffective.

In another preferred embodiment decreasing adverse environmental effects comprises affecting rumen microbiota and/or reducing methane production in ruminant animals. Typically the birch bark extract is effective in modulating the metabolism of the rumen microbiota to a direction that is beneficial for the animal performance and methane emissions by reducing the methane production of ruminants and/or by increasing the production of microbial biomass and propionic acid in the rumen.

In a still further embodiment decreasing the formation and/or absorption of harmful substances in the animal digestive tract comprises binding mycotoxins, binding bacterial toxins and/or preventing growth of intestinal parasites.

Typically the birch bark extract is effective in binding mycotoxins or bacterial toxins. For mycotoxin contaminated feed, which usually contains several mycotoxins, a broad-spectrum binder is required to prevent the harmful effects of the mycotoxins. Many of the traditional mycotoxin binders may be too selective e.g. the commonly used aluminium silicates are typically binding aflatoxin but do not have significant effects on the other toxins. The occurrence of mycotoxins varies by year and country but generally the most common mycotoxins are aflatoxin, ochratoxin, trichothecenes and zearalenone. Altogether those can contaminate up to 25% of the harvested crop globally. Consumption of mycotoxin contaminated feed may seriously reduce animal health and productivity and cause remarkable economic losses. The most common symptoms of mycotoxins in animal production include reduced appetite, immunity, growth and reproductive performance.

In another embodiment of the invention the birch bark extract of the modulating method and the feed composition is used for prevention of and in a medicament for treatment of gastrointestinal disorders of animals. The gastrointestinal disorders are preferably selected from the group consisting of weaning diarrhea, necrotic enteritis, chronic enteritis and coccidiosis. Typically the birch bark extract is used in prevention of gastrointestinal disorders of animals.

Typically the microbial modulator, i.e. the birch bark extract is effective in preventing the growth of intestinal parasites, like Eimeria spp. and Cryptosporidiosis. The intestinal parasites like Eimeria or Cryptosporidiosis are causing remarkable losses for the animal production. Eimeria is a genus of Apicomplexan parasites that includes various species responsible for the poultry disease coccidiosis. Symptoms of Eimeria infection i.e. coccidiosis include bloody diarrhea due to intestinal epithelium dying off since a large number of oocysts burst out of the cells. Ionophoric coccidiostats for the parasite are used in feeds; however, drug resistance is common as well as possible drug residues in the meat once the animal is butchered. For these reasons there is a need to replace coccidiostats in feeds with safer alternatives. Cryptosporidiosis on the other hand is an intestinal disease of humans and animals caused by the protozoan parasite Cryptosporidium parvum. The disease costs the dairy industry millions of dollars annually due to poor weight gain and even death in young calves. At present there are no approved drugs or immune therapy to prevent or treat cryptosporidiosis. There is a need to find compounds capable to prevent or alleviate the problems caused by Cryptosporidiosis. Necrotic enteritis (NE) is a leading intestinal health problem in broiler flocks. The disease is caused by the bacterium Clostridium perfringens and is seen in two forms, namely the acute, clinical form which is easily seen and can cause widespread mortality and the subclinical form which seldom causes death but erodes performance.

Thus preferred embodiments of the invention relate to the use of the birch bark extract in a method and feed composition for enhancing nutrient absorption in upper and lower digestive tract, for preventing adverse for example pathological microbial processes, for enhancing animal performance and gastrointestinal health, for enhancing feed conversion rate, for changing microbial population and/or its metabolism, for decreasing adverse environmental effects and/or decreasing the formation and/or absorption of harmful substances in the animal digestive tract.

Typically the birch bark extract of the invention is added to the animal feed, feeding or feed composition in an amount of 0.1 to 10 kg/ton (where ton refers to metric ton), preferably 0.25 to 2.5 kg/ton of dry weight microbial modulator per dry weight of the feeding or the feed composition, i.e. of the total diet. The amount is for example 0.2, 0.3, 0.4, 0.5, 0.6, 0.7, 0.8, 0.9, 1, 1.5, 2, 3, 3.5, 4, 4.5, 5, 5.5, 6, 6.5, 7, 7.5, 8, 8.5, 9 or 9.5 kg/ton. In other typical embodiments of the invention the birch bark extract is added to animal feeding, a feed composition, a feed supplement, a feed premix and/or a natural healthcare product in corresponding concentrations as for the feed composition, preferably in an amount of 0.1-10 kg/ton, more preferably 0.25-2.5 kg/ton of dry weight microbial modulator per dry weight of the total amount of feed. Thus the relative amount of microbial modulator, i.e. the birch bark extract in the feed supplement, premix and/or natural healthcare product is usually higher than in the feed composition, but the amount compared to the total amount of feed corresponds to the amount of birch bark extract in the feed composition. In a further embodiment of the invention the birch bark extract of the invention is given to an animal as such without adding it to feed, preferably in a feeder. Typically the bark extract is added to the feed supplement or premix at such a dose that the amount of bark extract in the final complete feed is 0, 1-10 kg/ton, more preferably 0.25-2.5 kg/ton. The typical moisture content is 12%.

The bark used in the extract of the invention is usually grinded and/or powdered before extracting it to produce the extract which is added to the animal feeding or feed composition, feed supplement, feed premix and/or natural healthcare product.

In preferred embodiments of the invention the microbial modulator of the modulating method and the feed composition comprises an extract of birch bark typically the birch bark extract comprises bark of birch (Betula), preferably bark selected from the group consisting of bark of Betula pubenscens, Betula pendula and/or Betula papyrifera. In one preferred embodiment the birch bark extract comprises one or more active compounds being selected from the group consisting of lupeol, suberin or betulinol.

In one embodiment of the invention the active compound is obtained from waste or recycled material bark. In a preferred embodiment Suberin is obtained from waste material obtained during cork production and/or from used corks.

The animal feed or feed composition of the invention is typically given to animals such as monogastric animals, ruminants and aquaculture, preferably cows, beef cattle, pigs, poultry, sheep, goats, horses, cats, dogs, fish and shellfish.

The birch bark extract of the invention typically comprises 10 to 40 w-%, preferably 15 to 25 w-% of long chain fatty acids, 10 to 30 w-% of Betulinol and 10 to 40 w-% of long chain fatty acids and phenol complexes.

More in detail a preferred birch bark extract of the invention consists of or comprises 10 to 50 w-%, preferably 20 to 35 w-%, more preferably 20 to 30 w-% of Betulinol, 3 to 8 w-% of Lupeol and 10 to 40 w-%, preferably 10 to 20 w-% of long chain fatty acids. Typically the birch bark extract thereto comprises small amounts of lignin, preferably below 20 w-% and small amounts of metals, preferably below 1 w-%. Preferred birch bark extracts of the invention may further comprise other inactive or active components as well as fillers and/or solvents.

In the present specification and claims, the percentages or amounts of the components in the extracts and/or feed are calculated on the dry solids content by weight unless otherwise specified. The term ton stands for metric tonne.

The following examples are provided to further illustrate the invention and are not intended to limit the scope thereof. Based on the above description, a person skilled in the art will be able to modify the invention in many ways to provide protection for modulating animal digestive tract microbiota in a wide range of situations.

### Example 1

### Production of Birch Bark Extract

100 kg of birch outer bark was isolated using flotation with water. 450 kg of 60% iso-propyl alcohol and 40% water and 0.5 N NaOH were added. The reaction mixture was brought to boil and cooked for 30 minutes.

The liquid phase was filtrated from the solid phase and the solid phase was washed with boiling isopropyl alcohol. The liquid phase was filtrated again from the solid phase and the liquid phases were combined.

The pH of the liquid phase was adjusted to 3 using 0.5M sulphuric acid. The formed precipitate was filtrated and dried in room temperature. The total yield of birch bark extract was 40 kg.

The composition of the birch bark extract (i.e. the amounts of the main components) is presented in Table 1.

TABLE 1
Composition of birch bark extract (w-%).

| Birch bark extract | |
|---|---|
| Long chain fatty acids | 10-40% |
| Betulinol | 10-30% |
| Long chain fatty acids + phenol complexes | 10-40% |

In Table 1a it is shown a alternative preferred birch extract composition of the invention. More in detail this preferred birch bark extract of the invention consists of or comprises 20 to 50 w-%, preferably 20 to 35 w-%, more preferably 20 to 30 w-% of Betulinol, 3 to 8 w-% of Lupeol and 10 to 40 w-%, preferably 10 to 20 w-% of long chain fatty acids, such as suberin. Typically the birch bark extract thereto comprises small amounts of lignin, preferably below 20 w-%.

TABLE 1a
Composition of a preferred birch bark extract (w-%).

| Birch bark extract | |
|---|---|
| Betulinol | 20-50% |
| Lupeol | 3-8% |
| Long chain fatty acids | 10-20% |
| Lignin | 0-20% |

### Example 2

Improved Feed Conversion Rate with Broilers and Piglets and Pathogen Elimination from Digestive Tract

The effect of birch bark extract on animal growth, feed consumption and feed conversion rate was tested in a broiler trial and a piglet trial. The extracts were obtained by the procedure described in Example 1.

In broiler trial newly hatched male chicks were randomly divided in groups of six. The number of tested product candidates were two, each tested at two doses. Each test feed was fed to five floor pens (6 birds/pen). One group of birds served as a control with no products amendment. Hence, the total number of birds was 90 (3 treatments×5 pens×6 birds/pen). The formula of the basic diet was conventional broiler feed that was supplemented as listed below.
1. Control diet with no amendments
2. Birch bark extract, 0.6 kg/tn
3. Birch bark extract, 2.4 kg/tn

The newly hatched broiler chickens were fed for 21 days prior to killing Feed consumption per pen was measured daily throughout the feeding period and all animals were individually weighed at slaughter to enable correlation of body weight gain (BWG).

In piglet trial forty animals were divided in 12 pens of 2 piglets, so that 4 pens were fed with the same test feed. The average starting weight of the piglets was 8.25 kg. Starting weight of each piglet was recorded and the growth was determined after two weeks of feeding. Feed consumption in each pen was followed and animals were individually weighed at slaughter. The piglet was fed with standard piglet feed with no acids or antimicrobial compounds supplementation. The test substances and their dose levels in the feed are listed below.
1. Control diet with no amendments
2. Birch bark extract, 2.4 kg/tn

Subsequent to slaughter process digesta samples were instantly homogenized and sub-samples for various short chain fatty acid analyses and real-time PCR analyses were prepared. Bacteria in the digesta samples were separated by differential centrifugation, bacterial cell walls disrupted, and the chromosomal DNA quantitatively purified. The real-time PCR system is based on the detection and quantification of a fluorescent reporter. This signal increases in direct proportion to the amount of PCR product in a reaction. By recording the amount of fluorescence emission at each cycle, it is possible to monitor the PCR reaction during exponential phase where the first significant increase in the amount of PCR product correlates to the initial amount of target template.

The following bacterial Quantitative or real-time PCR (Q-PCR) panel was applied to the ileal digesta samples:
Total bacteria
Lactobacillus spp
Escherichia coli

The following bacterial Q-PCR panel was applied to the caecal digesta samples:
Total bacteria
Clostridial cluster I
Lactobacillus spp
Clostridium perfringens

Short chain fatty acids (SCFA) are the major microbial fermentation products that give information on the metabolic activities and fermentation patterns of the microbial community. SCFAs were analyzed by gas chromatography using a packed column for the analysis of free acids. The acids analysed for were acetic, propionic, butyric, iso-butyric, 2-methyl-butyric, valeric, iso-valeric, and lactic acid.

### Results

Both broiler and piglet trial, table 2 and 3, demonstrate that birch bark extract increases body weight gain and decrease feed consumption, which thereby enhance feed conversion rate (FCR). The improved FCR clearly demonstrates that birch bark extract are able to improve nutrient absorption process in both production animal species.

TABLE 2
Chicken trial, level 1 = 0.6 kg/tn, level 2 = 2.4 kg/tn

| | Weight gain | | Feed consumption | | FCR | |
|---|---|---|---|---|---|---|
| No amendment | 0.71 kg | | 1.38 kg | | 1.97 | |
| | (s.e. | | (s.e. 0.03 kg) | | (s.e. | |
| | 0.03 kg) | | | | 0.1) | |
| Birch bark extract | 0.71 kg | 0% | 1.32 kg | −5% | 1.88 | −4% |
| level 1 | (s.e. | | (s.e. 0.03 kg) | | (s.e. | |
| | 0.05 kg) | | | | 0.1) | |
| Birch bark extract | 0.75 kg | +6% | 1.36 kg | −2% | 1.80 | −9% |
| level 2 | (s.e. | | (s.e. 0.01 kg) | | (s.e. | |
| | 0.006 kg) | | | | 0.02) | |

s.e. stands for standard error

TABLE 3
Piglet trial, dose level 2.4 kg/tn

| | Weight gain | | Feed consumption | | FCR | |
|---|---|---|---|---|---|---|
| No amendment | 4.19 kg | | 10.56 kg | | 2.69 | |
| | (s.e. | | (s.e. 0.9 kg) | | (s.e. 0.3) | |
| | 0.5 kg) | | | | | |
| Birch bark | 4.94 kg | +18% | 9.37 kg | −11% | 2.03 | −25% |
| extract | (s.e. | | (s.e. 0.2 kg) | | (s.e. 0.2) | |
| | 0.6 kg) | | | | | |

s.e. stands for standard error

Table 4 shows that birch bark extract is able to reduce the number of C. perfringens cells for broiler chicken's caecum. C. perfringens is a known pathogen of chickens causing necrotic enteritis disease that in mild cases decreases animal growth and in severe cases kills animals. Furthermore, C. perfringens infection is often triggered by other disease factors. For example Eimeria parasite infection often cause concomitant C. perfringens outbreak in chicken caecum. This finding demonstrates that birch bark extract is able to reduce the risk of disease in broiler chicken production. The results are thereto statistically significant (p≦0.1).

Table 5 shows that the birch bark extract decreases clostridial cluster I and C. perfringens microbial cell numbers in piglet caecum. Clostridial cluster I members are known pathogens for pigs and humans. The finding demonstrates that birch bark extract is able to reduce pathogen risk not only in host animal but also among human end users.

TABLE 4
Chicken trial, level 1 = 0.6 kg/tn, level 2 = 2.4 kg/tn

Clostridium perfringens
(16SrRNAgenes/g)

| | | |
|---|---|---|
| No amendment | 8.6E+07 | |
| | (s.e.4.9E+07) | |
| Birch bark extract | 4.2E+06 | −95% |
| level 1 | (s.e. 2.3E+06) | |
| Birch bark extract | 3.9E+07 | −55% |
| level 2 | (s.e. .8E+07) | |

s.e. stands for standard error

TABLE 5
Piglet trial, dose level 2.4 kg/tn

| | Clostridial cluster I | | Clostridium perfringens | |
|---|---|---|---|---|
| | (16SrRNAgenes/g) | | (16S rRNAgenes/g) | |
| No amendment | 5.6E+07 | | 2.5E+06 | |
| | (s.e. 2.6E+07) | | (s.e. 1.8E+06) | |
| Birch bark | 4.8E+07 | −15% | 2.1E+06 | −15% |
| extract | (s.e. 2.0E+07) | | (s.e. 1.3E+06) | |

s.e. stands for standard error

### Example 3

### Microbial Modulation

Bark extract's potential to beneficially modulate digestive tract microbiota and metabolism was studied by using a pig ileum and colon laboratory simulation system. A laboratory simulation system was used instead of animal model, because a laboratory model creates a more isolated and accurate system than animal models to measure substances' effects on digestive tract microbial community structure and fermentation types.

### Laboratory Simulation Protocol

### Preparation of Growth Medium and Inoculum for the Simulations

The conditions for small intestinal and colon simulations were kept as authentic as possible, and therefore, six healthy piglets on normal pig feed, containing no feed ingredients or additives were slaughtered and their intestinal contents were used to prepare growth medium and microbial inoculum as described below.

For the preparation of the growth media, the last third of small intestine and middle part of colon were isolated from piglet digestive tract, except the most distal part of small intestine was discharged to avoid caecal contamination. The both compartments were emptied and transported on ice to the laboratory. In laboratory majority portion of both compartment contents were centrifuged to remove solid particles and the clarified supernatant was used as an authentic growth medium in subsequent simulations. The smaller portion of both compartments was quickly frozen and used as inoculates for small intestine and colon simulations.

### Preparation of Simulation Vessels and Initiation of Simulation

The growth medium, inoculum, test products and the buffer were individually weighted or pipeted in serum bottles, and then flushed with CO₂ which had been passed through a hot copper catalyst for ultimate O₂ removal, and sealed with thick butyl rubber stoppers. After sealing, the vessels were transferred to 38° C. temperature and continuously shaken gently at about 100 rpm.

### Simulation Vessel Content for Small Intestine Simulation

2 ml of authentic ileal media
100 mg of small intestinal digesta
5 ml of phosphate buffer
Without redox-mediator
3 ml of water
Test products

### Simulation Vessel Content for Colon Simulation

2.5 ml of authentic colon media
10 mg of colon digesta
5 ml of phosphate buffer
With redox-mediator to ensure low redox-potential
2.5 ml of pathogen suspension
Test products
   Test Products and their Concentrations

| | |
|---|---|
| Negative control | 0 mg/10 ml simulator |
| Birch bark extract | 5 mg/10 ml simulator |

Measurements after Simulation

After 14 hours of incubation for ileal simulations and after 24 hours of incubation for colon simulations, the simulation vessels were sampled for the analysis of pH, short chain fatty acids (SCFAs) and various microbial quantifications.

Bacterial quantifications were performed by using Q-PCR measurement technology and specific primer sets.
Total microbes for samples from both ileal and colon simulations
Lactobacillaceae for samples from both ileal and colon simulations
Escherichia coli analysis for samples from both ileal and colon simulations

SCFAs were analyzed by gas chromatography using a packed column for the analysis of free acids. The following acids were analysed; acetic, propionic, butyric, iso-butyric, 2-methyl-butyric, valeric, iso-valeric, and lactic acid.

### Results of Simulation

Table 6 indicates that birch bark extract reduces the number of microbes in the upper digestive tract. Similarly birch bark extract reduces lactobacillaceae and E. coli numbers. Lactobacillaceae is the major inhabitant of upper digestive tract and cause major part of microbial competition over nutrient absorption and E. coli is known as an opportunistic pathogen causing diarrhea. The table 6 results therefore proves that the birch bark extract modulate the upper digestive tract microbiota and thereby reduce the microbial competition over nutrients and/or eliminate known pathogens.

Table 7 demonstrates that birch bark extract decreases Lactobacillaceae amounts and also the relative concentration of lactic acid in colon, which both are regarded as negative performance parameters. For example, a large amount of lactic acid is accumulated in colon in lactose intolerance disease that cause severe diarrhea soon after lactose containing food components have been eaten.

TABLE 6
Effect of birch bark extract on total microbial numbers and specific
microbial groups in simulated ileum.

| | Total Microbes | | Lactobacilloceae | | E. coli | |
|---|---|---|---|---|---|---|
| No amendment | 1.3E+10 | | 1.5E+08 | | 2.1E+09 | |
| | (s.e.4.4E+08) | | (s.e. .2E+06) | | (s.e.3.2E08) | |
| Birch bark extract | 1.1E+10 | −17% | 1.3E+08 | −11% | 1.7E+09 | −20% |
| | (s.e. .5E+09) | | (s.e. .5E+07) | | (s.e. .8E+08) | |

s.e. stands for standard error

TABLE 7
Effect of birch bark extract on total microbial numbers and
specific microbial groups in simulated colon.

| | |
|---|---|
| Loctobacillaceae | Lactic Acid % |

| | | | | |
|---|---|---|---|---|
| No amendment | 9.8E+08 | | 5% | |
| | (s.e. .9E+07) | | (s.e. 0.2%) | |
| Birch bark extract | 1.0E+09 | 2% | 4% | −1% |
| | (s.e. .2E+08) | | (s.e. 0.2%) | |

s.e. stands for standard error

The amounts of the microbial modulator i.e. bark extracts used for the simulation were comparable to the amounts used in the microbial modulation of Example 2.

### Example 4

### Pathogen inhibition test

C. perfringens was grown under standardized growth media and conditions to reach visually significant turbidity. Thereafter, a 1:1 dilution of caecal supernatant were mixed with standard growth media and it was inoculated with about 1:100 with turbid C. perfringens culture and supplemented with two test substances in three different dose levels. The growth and growth inhibition were measured by using turbidity (at 592 nm). The concentrations of test substances are listed below.
Negative control, no amendments
Birch bark extract low dose level (0.6 mg/ml)
Birch bark extract medium dose level (1.2 mg/ml)
Birch bark extract high dose level (2.4 mg/ml)

### Results

Table 8 illustrates that the use of birch bark extract directly inhibit C. perfringens growth. C. perfringens is a known pathogen for broilers causing necrotic enteritis disease, and its growth reduction is likely to cause a reduced risk of disease. Based on the results of Example 2 and because C. perfringens is closely relative to other clostridial cluster I members, it is expected that the bark extracts also inhibit the clostridial cluster I pathogens and therefore reduce the risk of diseases among other animal species and humans.

TABLE 8
The plus and minus signs indicate the magnitude of the effect
when compared to the negative control treatment as follows:
(− stands for inhibition and + stands for no inhibition)

| Pathogen | | C. perfringens | | |
|---|---|---|---|---|
| inhibition | | 2 h | 4 h | 6 h |
| Birch bark | low | | − − | |
| extract | mid | | − | |
| | high | | − | − |

effect >40%: +++
effect >25%: ++
effect >10%: +
effect <−40%: −−−
effect <−25%: −−
effect <−10%: −

The amounts of the microbial modulator i.e. bark extracts used for the simulation were comparable to the amounts used in the microbial modulation of Example 2.

### Example 5

### Disease Prevention Test

Pathogenesis of E. coli is typically initiated by its attachment to epithelial cell lining of the digestive tract, and therefore the most virulent strains are often recognized through their binding property (for example K88 strains). The substances efficacy to prevent attachment and the disease thereafter was studied with an attachment inhibition test model where authentic mucus recovered from slaughtered animals was purified and used to coat reaction vessels the surface of which absorbed the mucus. Virulent E. coli strain was grown in the presence of radioactive substrate under the conditions optimized for label uptake. The washed, labeled bacteria were added in the mucus-coated reaction vessels in the presence and absence of test substance, birch bark extract (10 mg/ml). After a short incubation, non-adhered bacteria were washed off and the remaining radioactivity measured. The numbers of bacteria adhering in the presence of test compounds were compared to those adhering in the absence of the compounds.

### Results

An attachment inhibition test of E. coli summarized in table 9 demonstrates that birch bark extract inhibit E. coli binding to the gut epithelial mucus lining. The attachment process is required to initiate the E. coli infection or at least the attachment facilitates the E. coli infection process. Thus, the inhibition of attachment is expected to reduce the risk of E. coli infection or alleviate the symptoms of E. coli infection. E. coli is close related to other intestinal pathogens, and therefore the attachment inhibition is expected to the same also for related pathogens, such as Salmonella.

TABLE 9
E. coli attachment and its inhibition by birch bark extract

Relative attachment
strength of E. coli

| | lleum % | s.e. | Colon % | s.e. |
|---|---|---|---|---|
| No amendments | 100 | 6.8 | 100 | 7.8 |
| Birch bark extract | 25.4 | 1.54 | 69.9 | 4.65 |

s.e. stands for standard error

The amounts of the microbial modulator i.e. the bark extract used for the simulation were comparable to the amounts used in the microbial modulation of Example 2.

### Example 6

### Decrease of Methane Emission from Ruminants

Methane emission studies are difficult or even impossible with live animals like cows. Therefore, a continuous rumen fermentation system was used to study test subtances's efficacy to decrease rumen methane emission. The fermentation simulation was initiated with 0.5 g (dry wt) of feed, fresh inoculum from a fistulated cow, and fermentation buffer mimicking ruminant saliva. Feed used for simulation contained 1:1 standard compound feed and acod-preserved grass silage. The whole procedure was accomplished under complete anaerobiosis at 37° C. in order to mimic rumen system as closely as possible. The fermentation was continued for 24 hours after initiation and then 20% of fermentation vessel content was transferred to a new simulation vessel that was prepared as described above, except that no fresh rumen inoculum was used for re-inoculation. This continuous re-inoculation procedure was continued for 7 days. The gas production was measured at 6 and 24 hours after the re-inoculation. All gas produced during each 24 hours fermentation period was collected and used for methane analysis.

### Results

Table 10 shows that birch bark extract decreases significantly rumen methane emission. The reduction of methane demonstrates the birch bark extracts' ability to modulate rumen fermentation either by inhibiting methanogenic microbes through various possible mechanisms and/or by affecting metabolic routes leading to methane synthesis. Furthermore, volatile fatty acid and total microbial number determinations indicate that during day 4, 5 and 6 there was a significant increase of propionate and microbial biomass production.

TABLE 10
Relative methane production during six days simulated rumen fermentation in
the presence of birch bark.

| | Day 1 | | Day 2 | | Day 3 | | Day 4 | | Day 5 | | Day 6 | |
|---|---|---|---|---|---|---|---|---|---|---|---|---|
| No | 100 | | 100 | | 100 | | 100 | | 100 | | 100 | |
| amendment | (s.e. .9)) | | (s.e. 3) | | (s.e. | | (s.e.7.4) | | (s.e. 1.5) | | (s.e. 0.6) | |
| | | | | | 2.6) | | | | | | | |
| Birch | 72 | −28% | 54 | −46% | 42 | −58% | 45 | −55% | 32 | −68% | 38 | −62% |
| bark | (s.e. .7) | | (s.e. 1.7) | | (s.e. | | (s.e. 4) | | (s.e. 2.2) | | (s.e. 5.1) | |
| | | | | | 2.3) | | | | | | | |

s.e. stands for standard error

The amounts of the microbial modulator i.e. bark extracts used for the simulation were comparable to the amounts used in the microbial modulation of Example 4.

### Example 7

### The Capacity of Birch Bark (Comprising Suberin) Extract to Bind Pathogenic E. coli F4 Serotype O149

The pathogenic E. coli bacteria serotype O149 were grown overnight in liquid media, harvested by centrifugation and washed three times with saline. After the last wash the pellet was suspended in phosphate buffered saline (PBS). The bacterial stock prepared was quantified with a cytometric bacterial counting method presented earlier. The quantified bacteria were stained with carboxyfluorescein diacetate succinimidyl ester (CFDASE). The staining reaction was stopped after 20 min and the excess dye was washed away with 10% bovine serum albumin-PBS suspension. The intensity of the staining was cytometrically verified.

A hydrolyzed yeast product Progut® was used as a positive control and spruce and pine bark extracts as further controls. The test products were suspended in PBS (0.15 g/25 ml) and incubated at room temperature for 2 h. The labeled bacteria (20-40×10⁶/ml) were then mixed with the PBS suspended product aliquot and co-incubated at 37° C. in an agitating incubator for 2 h. After the co-incubation the samples were centrifuged at low speed when the bacteria bound to the product were cleared from the supernatant. The reduction in CFDASE-fluorescence in the supernatant is proportional to the amount of bound and cleared bacteria. Bacteria binding performance percentage (BBP-%) for the products tested was calculated with the following equation:

BBP-%=[1−(d−c)/(b−a)]×100%, where:

a=PBS alone in pre-incubation & co-incubation
b=PBS alone in pre-incubation & co-incubated with labelled bacteria
c=PBS suspended product in pre-incubation & co-incubation
d=PBS suspended product in pre-incubation & co-incubated with labelled bacteria
(a, b, c & d=fluorometric counts from the supernatants after low speed centrifugation)

The results are shown in Table 11 and FIG. 1. All the barks extracts were efficiently binding the pathogenic E. coli strain and were as effective as the positive control product. By binding the pathogenic E. coli the bark extracts are capable to decrease the attachment of the bacteria into intestinal mucus and to decrease infections caused by the bacteria.

TABLE 11
Bacteria binding performance of the pathogenic E. coli

| | Binding % |
|---|---|
| Progut ® | 68 |
| Birch bark extract | 63 |
| Spruce bark extract | 74 |
| Pine bark extract | 74 |

### Example 8

### The Effect of Birch Bark Extract on Clostridial Cluster XIV and IV and Bacteroides Cluster

Maintaining balanced microbial population in lower digestive tract is important for piglet growth and health. Maintaining or increasing the number of beneficial microbes is known to prevent diseases and improve feed conversion rate. The main microbial groups in piglet lower intestine are Clostridial cluster XIV and IV and Bacteroides cluster. The effect of birch bark extract on the number of these three microbial groups was studied in piglet animal trial by using cluster specific PCR primer quantification system.

In this animal trial piglets were fed with standard piglet feed with no acids or antimicrobial compounds supplementation. The test substances and their dose levels in the feed are listed below.
1. Control diet with no amendments
2. Birch bark extract, 2.4 kg/tn

The microbial DNA extraction and PCR quantification were performed as described in Example 4 by utilizing PCR primers specific to three microbial clusters, Clostridial XIV and IV and Bacteroides.

### Results

The results shown in Table 12 indicate that the birch bark extract increases the number of microbes belonging to three most important microbial clusters, and therefore birch bark extracts, if added to piglet feed, are likely to improve piglet FCR and prevent diseases.

TABLE 12
Effect of birch bark extract on three
major microbial clusters of piglet colon.

| | Clostriadial | Clostriadial | Bacteroides |
|---|---|---|---|
| | cluster XIV | cluster IV | clusters |
| No amendments | 2.3E10 | 3.1E10 | 4.4E09 |
| Birch bark extract | 3.6E10 | 5.2E10 | 1.3E10 |

### Example 9

### The Effect of the Birch Bark Extract on the Performance of Dairy Cows

Addition of birch bark extract in feed was studied in a trial to investigate its effects on milk yield and feed efficiency of dairy cows. There were 21 mid-lactation cows in the trial that was arranged according to 3*3 Latin square design with three treatments and three trial periods. The feeding treatments were control, yeast addition and birch bark extract addition at 5 grams per cow and day. The length of the trial periods was three weeks. Milk yield was measured daily, milk composition four times during the trial and feed intake individually on daily basis. Average individual results from the last week of each trial period were calculated for statistical analysis. The average results were tested with analysis of variance using SAS GLM procedure. The differences between the treatments were tested with Tukeys t-test.

### Results

Milk yield and milk protein yield tended to be higher in the birch bark extract treatment in comparison to the control (table). The cows in the birch bark treatment tended also to produce more milk per ingested amount of energy. The efficiency of protein utilization was significantly (p<0.004) better in the birch bark extract treatment than the control.

TABLE 13
Effect of birch bark extract on three
major microbial clusters of piglet colon.

| | | | Birch | P-value |
|---|---|---|---|---|
| Treatment | Control | Yeast | extract | control vs. birch |
| Energy corrected milk | 40.3 | 40.4 | 41.0 | 0.12 |
| yield, ECM kg/d | | | | |
| Milk protein yield, kg/d | 1.32 | 1.32 | 1.35 | 0.07 |
| Milk fat yield, kg/d | 1.68 | 1.69 | 1.71 | |
| Energy efficiency, | 0.140 | 1.141 | 0.143 | 0.12 |
| ECM/ME kg/MJ | | | | |
| Protein efficiency, milk | 0.311 | 0.315 | 0.321 | 0.004 |
| protein g/feed protein g | | | | |

### Example 10

### The Effect of the Birch Bark Extracts on the Performance of Broilers Under Eimeria Maxima Challenge

Coccidiosis is one of the most common and economically important intestinal diseases of broiler chicks worldwide. The pathogenic organisms behind coccidiosis are unicellular microparasites of genus Eimeria. Coccidiosis alone rarely leads into high mortality in poultry operations. However, it is often associated with secondary bacterial infections of the intestine, necrotic enteritis being the most severe. Necrotic enteritis is caused by Clostridium perfringens that is a normal inhabitant of broiler chick caecum, but also an opportunistic pathogen in the small intestine during coccidiosis.

In the beginning of the trial newly hatched chicks were divided into dietary and challenge treatments (Table 14). The 18 chicks in each treatment were divided into three pens on day 1, six chicks per pen. Weak and strong challenge refer to the dose of 2,000 or 20,000 Eimeria oocysts per bird, respectively.

TABLE 14
The number of broiler chicks in
dietary treatments and challenge groups.

| | Challenge treatments | | | |
|---|---|---|---|---|
| | Healthy | Weak | Strong | |
| Dietary treatments | control | challenge | challenge | Total |
| Control | 18 | 18 | 18 | 54 |
| Pine bark extract 0.5 kg/tn | — | 18 | 18 | 36 |
| Pine bark extract 1.0 kg/tn | — | 18 | 18 | 36 |
| Pine bark extract 2.0 kg/tn | — | 18 | 18 | 36 |
| Birch bark extract 0.5 kg/tn | — | 18 | 18 | 36 |
| Birch bark extract 2.0 kg/tn | — | 18 | 18 | 36 |
| Total no of chicks | 18 | 108 | 108 | 234 |

On day 14, all chicks except the healthy controls were challenged with Eimeria maxima by oral inoculation of oocysts into the crop in 2 ml volume of tap water Immediately before giving the challenge, chicks of the healthy control treatment were moved into another room with similar pens. The chicks were weighed individually on days 0, 7, 14 and 20. The weekly feed consumption was measured per pen, and the feed conversion ratio was calculated. On day 20, the chicks were killed by cervical dislocation and small intestinal and caecal samples were collected for further microbial analysis.

Student's t-test was used to analyse the effect of control pine bark extracts and birch bark extracts on the different parameters. Statistics were based on mean values for pens. All tests were made within the challenges and against the corresponding control. Student's t-test p-values correspond to: ˜p<0.1; *p<0.05; **p<0.01; ***p<0.001; ****p<0.0001.

### Results

At the end of the challenge period the control chicks in the weak and strong Eimeria challenge treatments were on average 13.4% and 7.9% smaller than the healthy chicks, respectively (Table 15). Both challenge levels also increased mortality compared to the healthy control. According to the post-mortem examinations the main cause for the mortality was necrotic enteritis. In the weak challenge treatment, the pine and birch bark extracts at highest doses increased significantly the growth and end weight of the chicks compared to the control. They also significantly lowered the mortality. Similar kinds of effects were not seen in the strong challenge treatment. The results clearly show that the birch bark extract is capable to prevent necrotic enteritis problems in broilers. Statistics were calculated against the challenged control treatment. Student's t-test p-values correspond to: ˜p<0.1; *p<0.05; **p<0.01; ***p<0.001; ****p<0.0001

TABLE 15
The results for the for the challenge period (days 14-20), given as pen mean ±
SE, N = 3.

| | Control | Pine 0.5 | Pine 1.0 | Pine 2.0 | Birch 0.5 | Birch 2.0 | Healthy |
|---|---|---|---|---|---|---|---|
| Weak challenge | | | | | | | |
| Growth 14-20 d | 304.3 | 312.3 | 292.1 | 391.2* | 342.9 | 350.0~ | 396.3 |
| Weight at 20 | 748.9 | 778.1 | 778.8 | 903.0* | 822.6 | 835.4** | 865.2* |
| days | | | | | | | |
| Mortality % | 35.6 | 5.6** | 18.9 | 0.0**** | 33.3 | 12.2* | 0.0**** |
| Strong | | | | | | | |
| challenge | | | | | | | |
| Growth 14-20 d | 285.0 | 353.0 | 266.7 | 316.4 | 236.5 | 270.1 | 396.3~ |
| Weight at 20 | 797.3 | 873.5 | 802.1 | 818.1 | 743.2 | 759.6 | 865.2 |
| days | | | | | | | |
| Mortality % | 16.7 | 27.8 | 16.7 | 13.3 | 18.9 | 27.8 | 0.0 |

### Example 11

### The Effects of Birch Bark Extract on Rumen Fermentation Parameters In Vitro

Rumen fermentation simulation was run with 1 g (dry weight) of feed including both grass silage and compound feed at a ratio of 1:1. Both compounds in a fixed volume of medium were mixed with the feed prior to inoculation. Fresh rumen fluid from a fistulated cow at the 5% level was used to inoculate the vessels.

The test products were as follows:

1. Control, no supplements
2. Birch bark extract −50 mg
3. Birch bark extract −25 mg

Each treatment was tested with five replicated simulation vessels. The simulation vessels were randomized prior to simulation. The simulation was continued for 24 hours at 37° C.

Methane produced was measured at 12 and 24 hours from individually collected gas samples. Short chain fatty acids were analysed at 12 and 24 hours by gas chromatography using a packed column for the analysis of free acids. The acids analysed for were acetic, propionic, butyric, iso-butyric, 2-methyl-butyric, iso-valeric, valeric, and lactic acid. All treatments were compared against negative control with no amendments using pair wise t-tests at risk level α=0.05.

### Results

The birch bark extract reduced the dose dependently the % of methane both at 12 and 24 hours of the simulation (FIG. 2). It also increased dose dependently the production of propionate and did not have any influence on the total production of the fatty acids (FIG. 3).

### Example 12

### The Effect of Different Fractions of Birch Bark Extract on the Microbial Metabolism in Broiler Simulation Trial In Vitro

This trial included crop, ileal and caecal simulation mimicking different parts of the intestinal tract of broilers. Fresh, pooled samples of crop, ileal or caecal contents of nine chickens from commercial broiler farms were used as inoculums. The inoculums were diluted with water (crop simulation) or with anaerobic buffer (ileal and caecal simulations) and each treatment was simulated in four replicate vessels in anaerobic conditions at 37 C for 8 (crop) or 12 (ileal and caecal) hours. The tested products in this trial were:
1) Negative control
2) Positive control (Narasin coccidiostat)
3) Crude birch bark extract of the invention (without any purification or separation)
4) Fraction A of the birch bark extract containing the fatty acid fraction and betulinol
5) Fraction B containing only the fatty acid fraction
6) Fraction C containing only the betulinol

Short chain fatty acid (SCFA) profiles were measured at the end of the simulations i.e. at 8 hours for crop simulation, and at 12 hours for ileal and caecal simulations to identify the possible differences in the microbial metabolism. ANOVA followed by post hoc tests were carried out for all parameters measured. Throughout, risk level p=0.05 was used and p-values correspond to Dunnett's test result (unless otherwise explicitly stated) with the following p-value limits for the stars used in Figs.:
p<0.05˜*
p<0.01˜**
p<0.001˜***
p<0.0001˜****

### Results

In the crop simulation the crude birch bark extract increased the % of acetic acid (FIG. 4), decreased the % of lactic acid and increased acetic acid to lactic acid ratio (FIG. 5). The effect was similar as with the positive control (Narasin), although less in magnitude. The positive effects of Narasin on the performance and intestinal health of broilers are well known. The separate fractions of fatty acids or betulinol did not have a similar effect. In the ileal simulation the birch bark extract decreased the total production of short chain fatty acids (SCFA), similarly to the positive control (FIG. 6). This indicates that the total number of microbes in the ileal simulation have been lower than the negative control. Similar reduction in the SCFA production was not seen with the different fractions of the birch bark extract, especially not with fraction C (betulinol) that increased the SCFA production.

The present invention has been described herein with reference to specific embodiments. It is however clear to those skilled in the art that the process(es) may be varied within the bounds of the claims.

1. A method for modulating animal digestive tract microbiota wherein the modulating comprises adding a birch bark extract to animal feed wherein the birch bark extract comprises
a. 10 to 50 w-%, preferably 20 to 35 w-%, more preferably 20 to 30 w-% of Betulinol and
b. 10 to 40 w-%, preferably 10 to 20 w-% of long chain fatty acids.

2. The method according to claim 1 wherein the birch bark extract further comprises 3 to 8 w-% of Lupeol.

3. The method according to claim 1 wherein adding birch bark extract to the animal feed comprises adding the birch bark extract to animal feeding, feed composition, feed supplement, feed premix, natural healthcare product and/or adding birch bark extract as such to a feeder or animal.

4. The method according to claim 1 or 2, wherein the extract of bark comprises bark of birch (Betula), preferably bark selected from the group consisting of bark of Betula pubenscens, Betula pendula and/or Betula papyrifera.

5. The method according to claim 1, wherein modulating animal digestive tract microbiota comprises enhancing nutrient absorption in upper and lower digestive tract, prevention of gastrointestinal disorders of animals, enhancing animal performance and gastrointestinal health, changing microbial population and/or its metabolism, enhancing feed conversion rate, decreasing adverse environmental effects and/or decreasing the formation and/or absorption of harmful substances in the animal digestive tract.

6. The method according to claim 5, wherein the prevention of gastrointestinal disorders of animals is selected from the group consisting of weaning diarrhea, necrotic enteritis, chronic enteritis and coccidiosis.

7. The method according to claim 5, wherein the animal performance comprises enhancing animal growth, milk yield and egg production.

8. The method according to claim 5, wherein changing of the microbial population comprises modulating the composition of the commensal microbiota and/or its metabolism and preventing, inhibiting and/or reducing undesired microbial growth and/or metabolism.

9. The method according to claim 5, wherein enhancing nutrient absorption in upper and lower digestive tract comprises reducing the total number of microbes in the upper digestive tract of monogastric animals.

10. The method according to claim 5, wherein decreasing adverse environmental effects comprises affecting rumen microbiota and/or reducing methane production in ruminant animals.

11. The method according to claim 5, wherein decreasing the formation and/or absorption of harmful substances in the animal digestive tract comprises binding mycotoxins, binding bacterial toxins and/or preventing growth of intestinal parasites.

12. The method according to claim 1, wherein the birch bark extract comprises one or more active compounds being selected from the group consisting of lupeol, betulinol or suberin.

13. The method according to claim 1 wherein the birch bark extract is added to the feed composition in an amount of 0.1 to 10 kg/ton, preferably 0.25 to 2.5 kg/ton.

14. The method according to claim 2 wherein the birch bark extract is added to the feed supplement, premix and/or natural healthcare product in an amount of 0.1 to 10 kg/ton, more preferably 0.25 to 2.5 kg/ton of the dry weight of the total amount of feed.

15. The method according to claim 1 wherein the animal feed is fed to animals, preferably monogastric animals, ruminants and aquaculture, more preferably cows, beef cattle, pigs, poultry, sheep, goats, horses, cats, dogs, fish and shellfish.

16. A feed composition wherein the feed composition comprises an amount of birch bark extract which is effective in modulating animal digestive tract microbiota and wherein said birch bark extract comprises
a. 10 to 50 w-%, preferably 20 to 35 w-%, more preferably 20 to 30 w-% of Betulinol, and
b. 10 to 40 w-%, preferably 10 to 20 w-% of long chain fatty acids.

17. The feed composition of claim 16 wherein the birch bark further comprises 3 to 8 w-% of Lupeol.

18. The feed composition of claim 16 wherein the birch bark extract and/or an active component thereof is added to the feed composition in an amount of 0.1 to 10 kg/ton, preferably 0.25 to 2.5 kg/ton of the dry weight of the total amount of feed.

19. The feed composition of claim 16 wherein the birch bark extract and/or an active component thereof is added to a feed supplement, premix and/or natural healthcare product in an amount of 0.1 to 10 kg/ton, more preferably 0.25 to 2.5 kg/ton of the dry weight of the total amount of feed.

20. The feed composition of claim 16, wherein the extract of bark comprises bark of birch (Betula), preferably bark selected from the group consisting of bark of Betula pubenscens, Betula pendula and/or Betula papyrifera.

21. The feed composition of claim 16, wherein the animal feed is fed to monogastric animals, ruminants and aquaculture, more preferably cows, beef cattle, pigs, poultry, sheep, goats, horses, cats, dogs, fish and shellfish.

22. The feed composition of claim 16, wherein the birch bark extract comprises one or more active compounds being selected from the group consisting of lupeol, betulinol or suberin.
